(19) United States
(12) Patent Application Publication
(10) Pub. No.: US 2024/0146163 A1
(43) Pub. Date: May 2, 2024

(54) METHOD FOR PRODUCING A SQUIRREL-CAGE ROTOR WITH COATED CAGE RING

(71) Applicant: Siemens Aktiengesellschaft, 80333 München (DE)

(72) Inventors: KLAUS BÜTTNER, Hollstadt (DE); KLAUS KIRCHNER, Ostheim (DE); MATTHIAS WARMUTH, Windshausen (DE)

(73) Assignee: Siemens Aktiengesellschaft, 80333 München (DE)

(21) Appl. No.: 18/280,614

(22) PCT Filed: Mar. 1, 2022
(86) PCT No.: PCT/EP2022/055031

§ 371 Date: Sep. 6, 2023

(30) Foreign Application Priority Data
Mar. 16, 2021 (EP) 21162851.6

(51) Int. Cl. H02K 17/16; H02K 3/02; H02K 15/00; H02K 15/02; H02K 15/12

(52) U.S. Cl. CPC H02K 17/166; H02K 3/02; H02K 15/0012; H02K 15/02; H02K 15/12; H02K 2201/06; H02K 2203/09

(57) ABSTRACT

In a method for producing a short-circuit rotor of an asynchronous machine, a laminated core is formed with substantially axial slots and with an axial skew over an axial length of the laminated core, which axial skew is 0.3 to 3 times a slot pitch of the rotor. Conductor bars made of a first conductive material are inserted into the slots such that the conductor bars protrude out of end faces of the laminated core in a skewed manner out of the laminated core to define overhangs. At least the overhangs are coated with a galvanic layer of aluminum, tin or a solderable alloy to provide a lubricating layer. Individual laminations of a second conductive material are axially pressed onto the conductor bars such that the individual laminations short-circuit the conductor bars and form a short-circuit ring, which is composed of multiple individual laminations.

The invention relates to a method for producing a short-circuit rotor with a coated short-circuit ring of an asynchronous machine, as well as the asynchronous machine itself and the use thereof in different, preferably industrial applications.

A rotor in electric asynchronous machines, in other words in particular short-circuit rotors, predominantly has stacked electric steel sheets containing slots. Within these are electrical conductors made of aluminum or copper. The ends of the conductors are connected outside the laminated core by a short-circuit ring.

Short-circuit rotors of dynamo-electric rotary machines in the lower performance range (up to approx. 1 MW) are produced using die-cast technology in a single work process. This material-bonded method is cost-intensive, since the die-cast molds are expensive and are subject to wear and tear comparatively quickly. Furthermore, during production there is a comparatively high spread in the quality of a short-circuit rotor produced in this way. This is apparent for example in the change in the quality of the molten mass in the crucible, by impurities in the molten mass during the casting process, by release agent or abrasion on the tool, as well as by shrinking or stress cracking during cooling of the die-cast metal.

In order to eliminate the quality losses that occur, even in the low performance range, the die-casting procedure is carried out for example under the influence of protective gas. Likewise tools with multiple ventilation options are provided, or even a re-alloying of the molten mass is carried out. These interventions enable the efficiency of the asynchronous squirrel-cage rotor to be increased, but for strength additional measures are necessary, which in particular include a high speed capability, such as for example support rings or the use of alloys to obtain higher strength values.

In the higher performance range or in special applications of dynamo-electric rotary machines, individual conductor bars are electrically and mechanically connected to a short-circuit ring. This is done for example by soldering or welding procedures, as can be seen from DE 3413 519 C2 and U.S. Pat. No. 9,570,968 B1.

However, a disadvantage of this, in particular in the case of soldering procedures, is that in these larger dynamo-electric machines short-circuit rings are present which have a circumferential solder trough which during the soldering process must be completely filled with solder. In this case only the volume of the rotor bars protruding into the solder trough is not filled with solder. Because of the high proportion of silver in the solder it does not make particularly good economic sense among other things to establish the soldered connection between the rotor bars and the short-circuit ring.

It is known from EP 3 402 057 A1 for short-circuit rings to be pressed onto conductor bar ends using high axial forces. Very high axial forces are necessary for this purpose, in order to obtain sufficient contact between the conductor bar and the short-circuit ring. If the conductor bars are arranged skewed in the laminated core—because of slot skewing in order to reduce cogging torques—there is a risk that the conductor bars will buckle.

Based on this, the object of the invention is to provide a method for producing a short-circuit rotor of an asynchronous machine that avoids the aforementioned disadvantages. Furthermore, the short-circuit rotor created should have comparatively good electrical properties, and it should also be possible to produce it economically. Furthermore, an asynchronous machine equipped therewith should be provided with high efficiency for a wide variety of industrial applications, in particular in the case of compactors and compressors.

The object in question is achieved by a method for producing a short-circuit rotor of an asynchronous machine using the following steps:
provision of a laminated core of the rotor with substantially axially running slots,
insertion of conductor bars into the slots made of a first conductive material, such that the conductor bars protrude out of the end faces of the laminated core,
provision of a specifiable number of pre-stamped individual laminations, each with a specified contour, made of a second conductive material,
individual, axial pressing of these individual laminations one after the other onto the conductor bars protruding from the end face of the laminated core, wherein the individual laminations short-circuit the conductor bars protruding from an end face and thus form a short-circuit ring.

The object in question is also achieved by a short-circuit rotor produced in accordance with the inventive method, wherein the short-circuit ring directly abuts the laminated core or is spaced apart therefrom.

The object in question is also achieved by an asynchronous machine with an inventive short-circuit rotor.

The object in question is also achieved by a drive system, in particular for compressors, compactors, conveyor systems, or vehicle drives with at least one inventive asynchronous machine.

Thanks to the inventive method, a method is provided in a simple manner which significantly reduces the work entailed in the production of powerful short-circuit rotors. Thus comparatively small forces are needed to axially press the individual laminations onto the conductor bars. Depending on requirements, the axial height of the short-circuit ring can be varied without great effort. Furthermore, thermal processes are only provided as an option, so that no heating-up phases and cooling-down times need be provided for in the production process. This creates contact connections between the conductor bar and the individual lamination with a comparatively high electrical conductivity, which also reduces thermal losses in the short-circuit ring.

The method can thus be automated in a simple manner.

These contact connections between the conductor bar and the individual lamination are thus equipped with a low electrical resistance, which also remains in place over the service life of the asynchronous machine.

In the inventive method the in particular stamped individual laminations, which then together form the short-circuit ring, are axially pressed onto the conductor bars with an oversize in the cold state, in other words at room temperature or ambient temperature. Because the individual laminations are axially pressed, the axial joining force is split up and thus significantly reduced compared to pressing an entire short-circuit ring. For example, the joining force for rotors with a shaft height of 100 is less than 50 kN. The oversize from the conductor bar to the recess in the individual lamination can thus be set higher, which above all brings about a long-lasting improvement in contact between the conductor bar and the individual laminations.

In order for the thermal losses to be further reduced, the conductor bars, preferably copper bars, are compressed after being axially inserted into the slots by axially pressing the individual laminations and thus abut the side walls of the slot at least in sections.

Alternatively, the conductor bars can be compressed not only axially, but also—where present—can be caulked via a slot opening in the slot.

The individual laminations, for example made from aluminum (Al) or copper (Cu), can be produced in the stamping process and thus have the high accuracy in the μm range that is customary in stamping technology. Thus the oversize between the conductor bar and the recess in the individual lamination can be set precisely.

In one embodiment the recesses in the individual laminations are closed in the circumferential direction, which additionally improves the contact. This is not possible in the case of an extruded short-circuit disk.

However, the recesses in the individual laminations can of course also be provided with a radial outward-pointing opening.

In a further embodiment the conductor bars, but at least the subsequent overhangs of the conductor bars out of the laminated core of the rotor, are coated with a galvanic layer made of Al, tin or a solderable alloy.

This coating has multiple functions:

it prevents oxidation on the surface of the conductor bars, in particular in the case of conductor bars made of copper. This oxidation would increase the electrical resistance at the transition from the conductor bar to the individual lamination(s) of the short-circuit ring, which would lead to unnecessary thermal losses in the short-circuit ring.

Furthermore, this coating serves as a lubricating layer when the individual laminations are axially pushed onto the overhangs of the conductor bars. As tests have shown, because the individual laminations are joined serially this coating hardly wears off, so that even the “last” individual lamination to be pushed on encounters a sufficient lubricating layer on the overhangs. Thus even with axial joining of the outer last individual lamination there is still a sufficient coating present on the overhangs of the conductor bars.

Optionally, the remaining layer on the surfaces to be connected—the inside of the recess of the individual lamination and the corresponding outside of the overhang of the conductor bars—can be used for a diffusion process. To this end, the individual laminations pressed on cold or at ambient temperature can be briefly heated by an externally applied induction coil.

The short-circuit ring consisting of individual laminations is in this case heated to a temperature that is higher than the melting point of the coating. In the case of a coating containing tin this would be in the region of 300° C.

The layer briefly liquefies and solidifies again. This process evens out the uneven stamped surfaces, measured in the μm range, in the recess of the individual laminations. The contact between the recess of each individual lamination and the overhang of the conductor bar thus becomes full-surface contact in the region of the short-circuit ring. Moreover, diffusion processes occur between the coating of the conductor bars and the individual laminations of the short-circuit ring, which bring about an improvement in the electrical connection between the conductor bars and the individual laminations.

In the production of the individual laminations, in particular using stamping tools, the lamination thickness and/or the diameter, as well as the number and/or contour of the recesses, can be set without great effort, as required.

The internal diameter of these individual laminations is preferably identical to or greater than the shaft diameter and/or smaller than or identical to the external diameter of the laminated core of the rotor.

Thanks to direct contact between the individual laminations, in other words of the short-circuit ring with the shaft, heat can be dissipated to the outside via the shaft during operation of the asynchronous machine.

Using this method, “cold” pressing of the individual laminations onto ends of conductor bars to create a layered short-circuit ring of a short-circuit rotor of an asynchronous machine, skewed rotor laminated cores can also be produced. The reduced joining force compared to joining an entire short-circuit ring prevents the conductor bars that protrude in a skewed manner out of the core from kinking or bending during the joining procedure. The skew over the axial length of the rotor laminated core is in this case 0.3 to 3 times a slot pitch of the rotor—in other words the circumferential distance between two adjacent slots.

Thanks to the inventive method it is also possible to produce short-circuit rings axially spaced apart from the laminated core. This is done either in that the overhang has a stop, or in that the adjustable axial joining force and an adjustable axial joining path positions the individual laminations axially precisely on the overhang of the conductor bars.

In principle, in each of the embodiments mentioned there is good electrically conductive contact between the individual laminations and the conductor bars. An electrically conductive contact axially between the respective individual laminations of a short-circuit ring is not sought and will only occur to a comparatively small extent, if at all, but this is of secondary importance for the operation of an asynchronous machine.

A short-circuit rotor produced in this way yields a comparatively high efficiency of an asynchronous machine and thus an efficient drive for a large number of industrial applications such as compactors and compressors.

The invention and further advantageous embodiments of the invention have been explained in greater detail below using exemplary embodiments illustrated in principle; it is shown in:

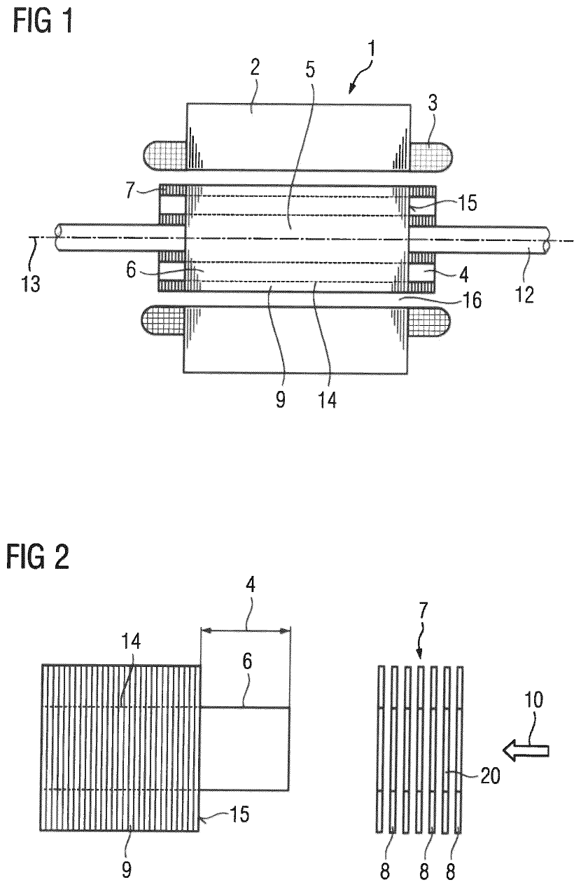

FIG. 1 in principle a longitudinal section of an electric asynchronous machine with a short-circuit rotor,

FIG. 2 in principle a production process,

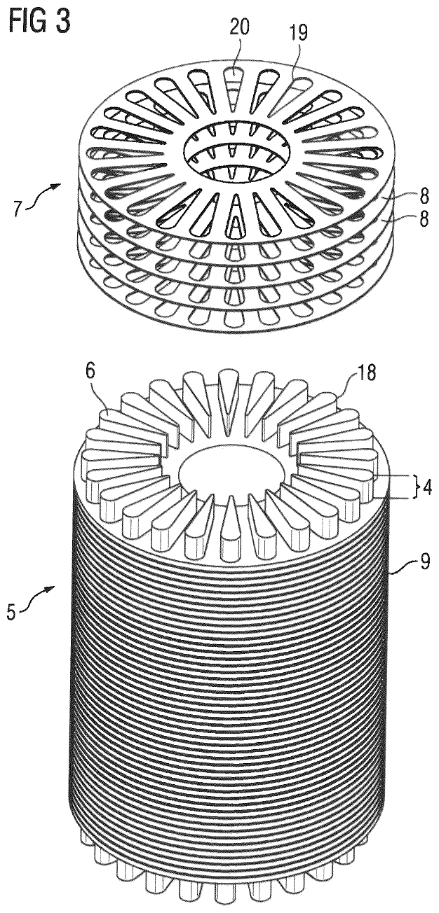

FIG. 3 a perspective representation of the production process,

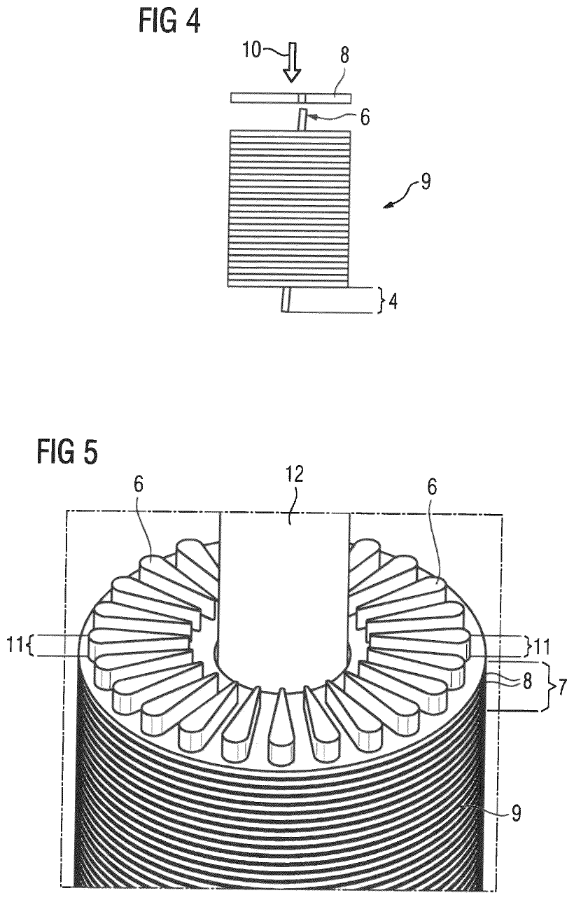

FIG. 4 in principle a production process with slots running axially skewed,

FIG. 5 a short-circuit rotor on a shaft,

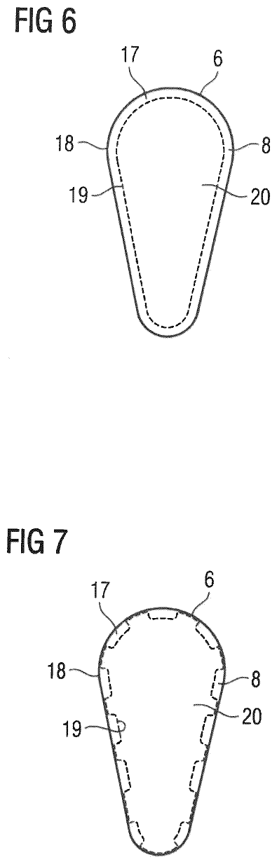

FIG. 6, 7 a representation of the oversize of the laminations on the conductor bars.

FIG. 1 shows a representation in principle of an electric asynchronous machine 1 with a stator 2, on the end faces of which are located winding overhangs of a winding system 3, which is arranged in substantially axially running slots of the stator 2. A rotor 5 is arranged radially spaced apart from the stator 2 and separated by an air gap 16, and is embodied as a short-circuit rotor.

In this case conductor bars 6 are arranged in substantially axially running slots 14 in a laminated core 9 of the rotor 5, and protrude axially at the end faces 15 of the rotor 5. Substantially axially running slots 14 here means slots 14 which do not have any skew in their axial course, in other words run parallel to the axis or have a skew of the slots 14 in their axial course which amounts to up to 3 times a slot pitch.

Short-circuit rings 7 are positioned at these overhangs 4 and short-circuit the individual conductor bars 6 on an end face 15. The short-circuit rings 7 are, as in this case, additionally in contact with a shaft 12, in order to enable a dissipation of heat via the shaft 12.

However, embodiments are likewise possible in which the short-circuit ring 7 is not in connection with the shaft 12.

In the case of the aforementioned embodiments the short-circuit ring 7 is in principle constructed from individual laminations 8 that are pushed onto the axial overhangs 4 of the conductor bars 6 of an end face 15, as is described in greater detail below.

Thanks to electromagnetic interaction of the energized winding system 3 of the stator 2 with the rotor 5 the rotor 5 which is non-rotationally connected to the shaft 12 is set in rotation about an axis 13. In this way driven machines, including compactors, conveyor belts or compressors, can be driven.

FIG. 2 shows a representation in principle of how the production process of a short-circuit ring 7 takes place in principle. The individual laminations 8 are placed with comparatively little axial joining force onto the overhang 4 of the conductor bars 6 which protrude out of the end face 15 of the laminated core 9 of the rotor 5. In this case the conductor bars 6 have an oversize 17 with respect to the respective openings in the individual laminations 8, as can also be seen for example in FIG. 6 and FIG. 7.

Advantageously in this case even the conductor bars 6 inside the laminated core 9 of the rotor 5 can run skewed, without the conductor bars 6 buckling due to the axial joining procedure 10.

The skew of a conductor bar 6, viewed over the axial length of the laminated core 9 of the rotor 5, can in this case be up to 3 slot pitches. A slot pitch is, viewed in the circumferential direction, the distance between two adjacent slots 14 of the rotor 5.

Viewed axially, the short-circuit ring 7 is now composed of multiple individual laminations 8 which are each in good conductive electrical contact with the conductor bars 6. An electrically good conductive contact axially between the individual laminations 8 on an end face 15 is not necessary and hence does not have to be supported by additional welding procedures or soldering procedures, which greatly simplifies the structure of a short-circuit rotor. The contact between the conductor bars 6 and the respective individual sheets 8 alone is sufficient to create a functional short-circuit rotor for an asynchronous machine 1 with a comparatively high degree of efficiency.

The short-circuit ring 7 thus consists of individual laminations 8. The joining force is thus split up during the production process of the short-circuit ring and can take place using comparatively small equipment, such as presses, etc., since the required joining forces are comparatively low. Thus skewed rotor cores, in other words laminated cores 9 with skewed slots 14, can now also be produced in a simple manner without the risk of the conductor bars 6 buckling in the region of the overhang 4.

A coating on the conductor bars 6, in particular of the copper bars, ensures that an oxide layer is prevented and is advantageous in respect of the joining procedure and the connecting surfaces between the conductor bar 6 and the respective individual laminations 8 of the short-circuit ring 7.

The press fit between the conductor bar 6 and the recess 20 in the individual laminations 8, which is carried out at least in sections, ensures a durability of the connection even under thermal load cycles of an asynchronous machine.

If the conductor bars 6 are allowed to overhang the short-circuit rings 7, these serve as fan blades in operation of the asynchronous machine. In this case the axial thickness of the short-circuit ring 7, in other words of the stacked individual laminations 8, is less than the overhang 4. The thermal loss in this case takes place directly axially out of the hot zones of the rotor 5.

FIG. 3 shows a perspective representation of the rotor 5 with its laminated core 9 and the overhangs 4 of the conductor bars 6 at the end face 15 of the laminated core 9. The individual laminations 8 are now pressed axially onto these overhangs 4 in order to obtain a short-circuit ring 7. Each individual lamination 8 is pressed individually, in order to reduce the axial joining force that would be necessary in the case of a solid short-circuit disk.

The slots 14 of the laminated core 9 of the rotor 5 are designed to be closed toward an air gap 16, and likewise it is possible to design these slots 14 as at least partially open in the direction of the air gap 16. The conductor bars 6, in particular copper, are in this case inserted axially into these slots 14.

The cross-sectional shape 19 of the recesses 20 in the individual laminations 8 is at least in sections undersized with respect to the cross-sectional shape 18 of the conductor bars 6, so that a pressing procedure is necessary to contact the conductor bars 6 and the individual laminations 8.

FIG. 4 shows in principle a representation of an assembly procedure for an individual lamination 8 onto a conductor bar 6 or the overhang 4 thereof, wherein the conductor bar 6 is arranged skewed in the laminated core 9 at a specified slot skew of the rotor 5. Because of the individual lamination 8 the force for the axial pushing-on 10 is comparatively small, so there is no possibility of the conductor bar 6 buckling in the region of its overhang 4.

FIG. 5 shows a partially perspective representation of a rotor 5 with its laminated core 9, a short-circuit ring 7 having already been applied by individual laminations 8. The conductor bars 6 protrude axially from the short-circuit ring 7 and in this way ensure air turbulence in operation of the asynchronous machine 1 and thus develop a cooling effect. In this embodiment, the laminated core 9 of the rotor 5 is non-rotatably connected to a shaft 12, in particular shrunk on.

FIG. 6 shows a cross-section of a conductor bar 6 and a recess 20 in an individual lamination 8. In this case the oversize 17 of the conductor bar 6 is shown, which in this way results in pressing and micro-welding with the respective individual laminations 8.

In this embodiment the oversize 17 is selected such that the cross-sectional shape of the conductor bar 6 and the cross-sectional shape of the recess 20 in the individual lamination 8 are identical. In this case the cross-sectional shape of the individual lamination 8 to obtain the oversize is dimensioned to be somewhat larger in order to obtain a press fit.

In FIG. 7, with a similar cross-sectional shape 18 of the conductor bar 6, the recess 20 in the individual lamination 8 is designed such that an oversize occurs only at certain sections. A subsequent flow of current from the conductor bar 6 onto the individual lamination 8 to adjacent conductor bars 6 is thus also only made possible in these sections.

The cross-sectional shapes of the recess 20, as well as of the conductor bars 6, need not in this case be identical and/or be oversized over the entire circumference, but there can also be oversized areas on the conductor bars 6 only in sections.

Such rotors 5 with inventive short-circuit rotors are used in asynchronous machines 1 that are intended as a drive system, in particular for compressors, compactors, conveyor systems, or vehicle drives. Because of the long operating times of such drive systems, a high efficiency of the drive systems is of advantage to the customer, in that energy costs are saved and/or battery systems in vehicles enable longer ranges.

1.-15. (canceled)

16. A method for producing a short-circuit rotor of an asynchronous machine, the method comprising:
forming a laminated core with substantially axial slots and with an axial skew over an axial length of the laminated core, which axial skew is 0.3 to 3 times a slot pitch of the rotor;
inserting conductor bars made of a first conductive material into the slots, such that the conductor bars protrude out of end faces of the laminated core in a skewed manner out of the laminated core to define overhangs;
coating at least the overhangs of the conductor bars with a galvanic layer made of aluminum, tin or a solderable alloy to provide a lubricating layer when axially pushing onto the overhangs of the conductor bars; and
individually axially pressing a specifiable number of pre-stamped individual laminations, which are made of a second conductive material and have each a specified contour, one after the other onto the conductor bars such that the individual laminations short-circuit the conductor bars and form a short-circuit ring, which is composed of multiple individual laminations.

17. The method of claim 16, wherein the conductor bars in the slots abut at least one section of side walls of corresponding ones of the slots and are fixed into the slots by axially pressing the individual laminations or by a separate caulking process.

18. The method of claim 16, wherein the individual laminations comprise a specifiable number of recesses which corresponds to a number of the slots.

19. The method of claim 18, further comprising oversizing the conductor bars compared to the recesses at least in one section so that in an axial joining procedure a permissible shear stress of the first conductive material of the conductor bars and of the second conductive material of the individual laminations are locally exceeded to cause a material transfer by diffusion at a boundary surface between the conductor bars and the individual laminations, resulting in micro-welding of the conductor bars and corresponding ones of the individual laminations.

20. The method of claim 16, wherein the first conductive material is copper or a copper alloy and wherein the second material is aluminum, copper or an aluminum alloy or copper alloy.

21. The method of claim 16, wherein the conductor bars are chamfered so as to have a circumference which is reduced in size.

22. The method of claim 16, wherein the conductor bars are chamfered in a region of the overhangs so as to have a circumference which is reduced in size.

23. The method of claim 16, wherein the individual laminations comprise recesses in a region of the conductor bars with a cross-sectional shape which substantially corresponds to a cross-sectional shape of the conductor bars, wherein the cross-sectional shape of the conductor bars is oversized, at least in one section, in relation to the cross-sectional shape of the recesses, in order to obtain a microweld between the conductor bars and corresponding ones of the individual laminations.

24. The method of claim 16, wherein at least one of the conductor bars is made of drawn electro-copper with a conductance of at least 58 MS/m.

25. The method of claim 16, further comprising heat treating the short-circuit rotor simultaneously or subsequently to raise a yield point of the individual laminations and/or to increase a conductivity between the conductor bars and the individual laminations.

26. The method of claim 16, further comprising stamping the individual laminations.

27. The method of claim 18, wherein the recesses in the individual laminations have a closed contour or a slotted contour.

28. A short-circuit rotor of an asynchronous machine, the short-circuit rotor comprising:
a laminated core with substantially axial slots and with an axial skew over an axial length of the laminated core, which axial skew is 0.3 to 3 times a slot pitch of the rotor;
conductor bars made of a first conductive material and inserted into the slots of the laminated core, such that the conductor bars protrude out of end faces of the laminated core in a skewed manner out of the laminated core to define overhangs;
a galvanic layer made of aluminum, tin or a solderable alloy for coating at least the overhangs of the conductor bars so as to provide a lubricating layer; and
a specifiable number of pre-stamped individual laminations made of a second conductive material and have each a specified contour, said individual laminations being individually axially pressed one after the other onto the conductor bars such that the individual laminations short-circuit the conductor bars and form a short-circuit ring, which is composed of multiple individual laminations, said short-circuit ring directly abutting the laminated core or being spaced apart from the laminated core.

29. The short-circuit rotor of claim 28, wherein the individual laminations of the short-circuit ring are electrically in contact with one another only via the conductor bars.

30. An asynchronous machine, comprising a short-circuit rotor, said short-circuit rotor comprising a laminated core with substantially axial slots and with an axial skew over an axial length of the laminated core, which axial skew is 0.3 to 3 times a slot pitch of the rotor, conductor bars made of a first conductive material and inserted into the slots of the laminated core, such that the conductor bars protrude out of end faces of the laminated core in a skewed manner out of the laminated core to define overhangs, a galvanic layer made of aluminum, tin or a solderable alloy for coating at least the overhangs of the conductor bars so as to provide a lubricating layer, and a specifiable number of pre-stamped individual laminations made of a second conductive material and have each a specified contour, said individual laminations being individually axially pressed one after the other onto the conductor bars such that the individual laminations short-circuit the conductor bars and form a short-circuit ring, which is composed of multiple individual laminations, said short-circuit ring directly abutting the laminated core or being spaced apart from the laminated core.

31. The asynchronous machine of claim 30, wherein the individual laminations of the short-circuit ring are electrically in contact with one another only via the conductor bars.

32. A drive system, in particular for compressors, compactors, conveyor systems, or vehicle drives, the drive system comprising an asynchronous machine as set forth in claim 30.
